(19) United States
(12) Patent Application Publication
(10) Pub. No.: US 2023/0325372 A1
(43) Pub. Date: Oct. 12, 2023

(54) HIERARCHICAL TO MATRIX DATA MANAGEMENT

(71) Applicant: United Parcel Service of America, Inc., Atlanta, GA (US)

(72) Inventor: Waleed Ahmed, Atlanta, GA (US)

(21) Appl. No.: 17/718,062

(22) Filed: Apr. 11, 2022

(51) Int. Cl. G06F 16/22; G06F 16/28

(52) U.S. Cl. CPC G06F 16/2237; G06F 16/289

(57) ABSTRACT

Systems and methods are provided for creating and utilizing an improved data structure. A hierarchical or nested data structure having a recursive first set of attribute-values may be converted into a matrix data structure having a second set of non-recursive attribute-values. Utilizing the static nature of a nested data structure, values may be extracted from the first set of attribute-values and translated or converted into row values of a matrix. A plurality of binary values associated with a common set of attributes can be concatenated into a binary sequence and converted to a single decimal number with a corresponding column value representing the set of attributes. Consolidating binary attribute-values and eliminating recursive attribute information creates significantly smaller file sizes, reducing the burden on network communication links and computer storage.

### TECHNICAL FIELD

The present disclosure generally relates to optimized data structures for use in high volume data environments. In particular aspects, this disclosure relates to networked logistic collaboration devices that generate and distribute a low-overhead data structure for capturing existing data structures in complex logistic systems.

### BACKGROUND

Typical logistics planning tools include lengthy series of data that relate to particular operational capabilities and characteristics. For example, a logistics carrier may have one or more logistic activities at a single location, with several locations in a region, wherein each logistic activity may have unique capabilities to handle certain operations that may be required by the carrier. For example, a particular logistic activity may have sufficient staffing and/or equipment to handle high priority parcels on certain days but insufficient on other days. Existing data sets capture these parameters using bulky nested structures that can become large files, slowing the process for strategic tracking of vast number of logistic activities, updating activity characteristics, simulators, and the like.

### SUMMARY

### BRIEF DESCRIPTION OF THE DRAWINGS

Having thus described the disclosure in general terms, reference will now be made to the accompanying drawings, which are not necessarily drawn to scale, and wherein:

FIG. 1 is a schematic diagram of an example computing environment in which aspects of the present disclosure are employed in, according to some embodiments.

FIG. 2 is a schematic diagram of a computing entity in which aspects of the present disclosure are employed in, according to some embodiments.

FIG. 3 shows a sequence diagram illustrating operations and processes that can be used for converting data from a nested structure to a hierarchal structure in accordance with various embodiments of the present invention.

FIG. 4 shows a sequence diagram illustrating operations and processes that can be used for utilizing hierarchal data structures in accordance with various embodiments of the present invention.

FIG. 5 illustrates a flow chart for a method for converting data from a nested structure to a hierarchical structure in accordance with various embodiments of the present invention.

FIG. 6 shows a set of data converted from a nested data structure to a hierarchical data structure in accordance with various embodiments of the present invention.

### DETAILED DESCRIPTION OF THE INVENTION

The present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. Like numbers refer to like elements throughout.

### I. Overview

Logistics networks are one specific example of highly-complex networked systems where one change to a particular activity, capability or characteristic, referred to herein generally as attributes or parameters, may have cascading effects. Because of the need to capture, communicate, and/or track the large number of attributes, existing data structures that include attribute data for a plurality of distinct entities can quickly become large files, particularly when the existing data structures are in the form of human readable text that comprises numerous attribute-value pairs/arrays (e.g., in JavaScript format). Because the existing data structures to define sized entity-attribute yield large files, networked computing resources required to store and communicate said files may experience resource shortages and slow transfer times, and frequently result in crashing client computing devices that attempt to download/upload the files. In some aspects, because logistic system planners may frequently make changes to an attribute of one or more entities, the slow transfer times associated with communicating and/or modifying existing data structures may frequently be realized by the network. In one example, a logistics system may comprise numerous distinct buildings, activities, or assets, each referred to and identified by an entity identifier (e.g., a standard location identification code (SLIC)). Each entity may comprise numerous attributes, which may have associated values or arrays; when stored in a human readable text format, the existing entity-attribute data structure may, itself, comprise dozens or hundreds of attribute-value entries. Thus, when a logistic network planner downloads/uploads a file (e.g., a sort calendar) for a particular geographic region, the file may be in the magnitude of several megabytes or gigabytes, or larger. Similar undesirable effects may occur when data structures for numerous geographic regions are compiled to provide strategic oversight or to simulate changes to the logistics network.

Various embodiments of the present disclosure improve the functioning of computer components, whether networked or stand-alone, to process large volumes of attribute-value data by creating an optimized data structure based on a conversion of human-readable data. For example, various embodiments are directed to a networked system for converting, communicating, and storing large volumes of attribute-value information that converts and stores data structures in the form of a human-discernable nested data structure in to a matrix data structure. As described in greater detail herein, a first set of attribute-value information may be converted at or near a client device into a second set of attribute-value information having an optimized data structure utilizing a matrix data structure. The second set of attribute-value information in the matrix data structure may be communicated and stored in one or more networked storage devices and may be accessed by one or more additional networked computing devices. Once the second set of attribute-value information is communicated to a requesting client, the data may be converted from the matrix data structure in to the nested data structure, for use by the requesting client. Real-world testing of the present invention reveals that the second set of attribute-value information yields file sizes as much as 40 times smaller than files having the first set of attribute-value information (which may be referred to herein as a “nested data structure”), vastly reducing the amount of networked resources required to communicate and store attribute-value information, thus improving the functioning of the networked devices, relative to the resources required to communicate and store attribute-value information in the nested data structure.

### II. Apparatuses, Methods, and Systems

Embodiments of the present disclosure may be implemented in various ways, including as apparatuses that comprise articles of manufacture. An apparatus may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and sequence diagram illustrations. Thus, it should be understood that each block of the block diagrams and sequence diagram illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and sequence diagram illustrations. Accordingly, the block diagrams and sequence diagram illustrations support various combinations of embodiments for performing the specified instructions, operations, or steps.

### III. Exemplary System Architecture

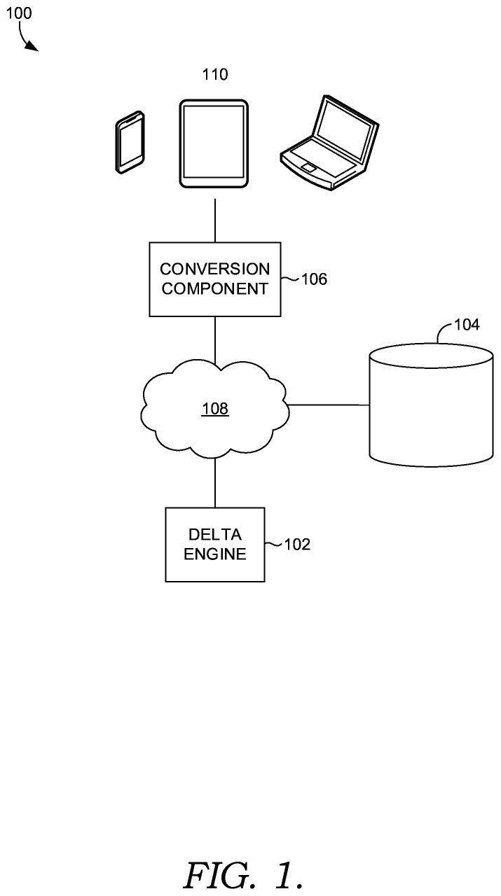

FIG. 1 is a schematic diagram of an example computing environment 100 in which aspects of the present disclosure are employed in, according to some embodiments. As shown in FIG. 1, this particular computing environment 100 includes one or more client devices (i.e., computing entities) 110, a conversion component 106, a delta engine 102, and one or more storage devices 104 configured to store data. Each of these components, entities, devices, systems, and similar words used herein interchangeably may be in direct or indirect communication with, for example, one another over the same or different wired and/or wireless networks, collectively represented by a network 108. Additionally, while FIG. 1 illustrates the various system entities as separate, standalone entities, the various embodiments are not limited to this particular architecture.

As shown in FIG. 1 and described above, the computing environment 100 may comprise the conversion component 106 and the delta engine 102. The computing environment 100 may have more or fewer computer processing components to accomplish the same objectives as the configuration set forth in FIG. 1. In one aspect, each of the conversion component 106 and the delta engine 102 comprise a software stack, hardware components configured to perform particular operations, or combinations thereof, for performing a particular functionality. For example, the conversion component 106 may comprise one or more computing components that are generally configured to convert a first set of attribute-value information stored in a nested data structure into a matrix data structure and from the matrix data structure to the nested data structure. In some aspects, the conversion component 106 may comprise a first conversion component that handles conversion from the nested data structure to the matrix data structure and a second conversion component may handle conversion from the matrix data structure into the nested data structure. In some aspects, the conversion component 106 may take the form of a software stack running on the computing device 110; however, in other aspects, the conversion 106 may comprise one or more computing components that is separate from the computing device 110. The delta engine 102 is generally configured to detect and reconcile changes to data structures between two different versions of data. Though shown as a single computer processing component, each of the conversion component 106 and the delta engine 102 may be divided into a plurality of discrete processing components, any one of which may comprise software or hardware components such as those described with respect to FIG. 1. Though referred to generically or colloquially as a database, the one or more storage devices 104 may take any desirable form for storing data (e.g., a server, couchbase, cloud/distributed storage, memory, and the like).

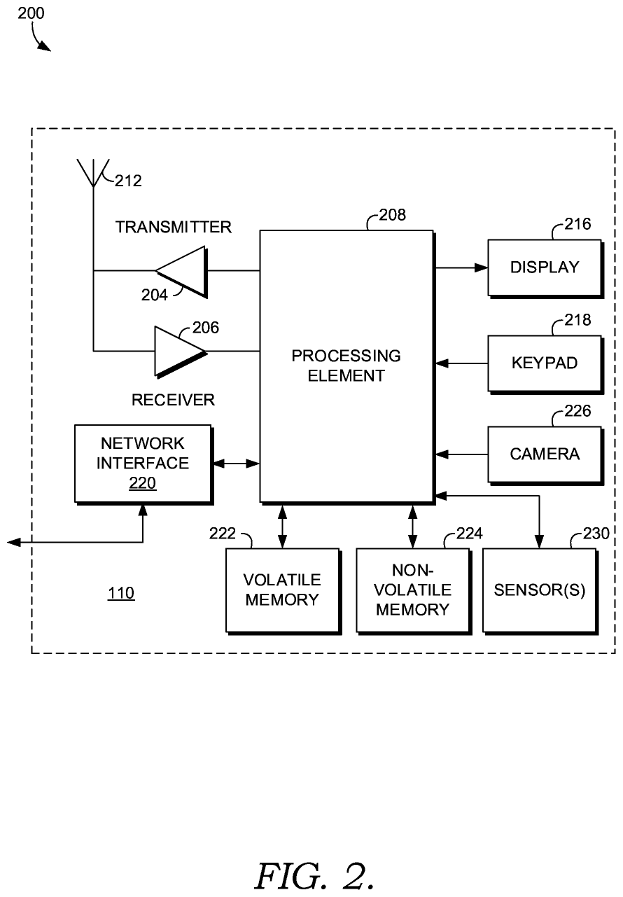

FIG. 2 provides a schematic of a computing entity 200 suitable for particular embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, consoles input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In particular embodiments, these functions, operations, and/or processes can be performed on data, content, information/data, and/or similar terms used herein interchangeably.

In general, the terms device, system, computing entity, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. For example, any one or more components of the computing entity 200 may comprise any one or more components of computing environment 100. For example, at least a portion of computing entity 200 may be a client device, such as computing device 110 in FIG. 1. At least a portion of computing entity 200 may be server, such as aspects where the conversion component 106 or the delta engine 102 comprise a server.

As indicated in FIG. 2, in particular embodiments, the computing entity 200 may include one or more communication interfaces 220 for communicating with various computing entities, such as by communicating data, content, information/data, and/or similar terms used herein interchangeably that can be transmitted, received, operated on, processed, displayed, stored, and/or the like. The computing entity 200 may include an air interface that comprises one or more of an antenna 212, a transmitter 204 (e.g., radio), a receiver 206 (e.g., radio), and a processing element 208 (e.g., CPLDs, microprocessors, multi-core processors, coprocessing entities, ASIPs, microcontrollers, and/or controllers) that provides signals to and receives signals from the transmitter 204 and receiver 206, respectively. The air interface may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. In some embodiments, the computing entity 110 includes one or more sensors 330. Using one or more of the communication interface 220 or the air interface, the computing entity 200 may be configured to interface with one or more other devices, components, or the network 109, of computer environment 100 of FIG. 1.

The computing entity 200 may also comprise a user interface (that can include a display 316 coupled to a processing element 208) and/or a user input interface (coupled to a processing element 208). For example, the user interface may be a user application, browser, user interface, and/or similar words used herein interchangeably executing on and/or accessible via the computing entity 200 to interact with and/or cause display of information from the logistics server(s) 105, as described herein. The user input interface can comprise any of a number of devices or interfaces allowing the computing entity 200 to receive information/data, such as a keypad 218 (hard or soft), a touch display, voice/speech or motion interfaces, or other input device. In embodiments including a keypad 218, the keypad 218 can include (or cause display of) the conventional numeric (0-9) and related keys (#, *), and other keys used for operating the computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes. The computing entity 200 may also include a camera, imaging device, and/or similar words used herein interchangeably (e.g., still-image camera, video camera) configured to capture images. The computing entity 200 may be configured to capture images via the onboard camera 226, and to store those imaging devices/cameras locally, such as in the volatile memory 222 and/or non-volatile memory 224. As discussed herein, the computing entity 200 may be further configured to match the captured image data with relevant network data. For example, the camera 226 may be used to capture an image of a visually-perceptile indicia, such as a QR code, 2D barcode, or the like, wherein the visually-perceptible indicia is a unique identifier that is associated with a particular object (e.g., a hub, center, link, conveyance, shift, or the like) which provide the basis for creating, modifying, or removing an proposed event, as discussed in greater detail herein.

The computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the computing entity 110. As indicated, this may include a user application that is resident on the entity or accessible through a browser or other user interface for communicating with the logistics server(s) 105 and/or various other computing entities.

### IV. Exemplary System Operation

As discussed above, complex logistics networks often involve vast amount of attribute-value data describing characteristics about logistic activities in a nested data structure. In many cases, the nested data structure may be human-perceivable, meaning it may contain extraneous information that may, in some cases, not be critical to communicating/storing information about said logistic activities. In some aspects, the nested data structure may include operational data in a nested data structure that includes a plurality of services, wherein each service has certain attributes. For example, at a first level of operational detail, a dataset may be relevant to a particular service area (e.g., a single service location identification code (SLIC)) such as Louisville, Kentucky. Operations at the Louisville SLIC may be divided into a plurality of tiers (e.g., days of the week), each day of the week may be further divided into a plurality of additional tiers (e.g., service groups such as ground services, next day air services, second day air services, and the like), which may be even further divided into additional tiers (e.g., ground service may be divided into domestic basic, domestic standard, economy, and the like). Regardless of how many tiers are used in the particular nested dataset, a nested dataset relevant to the particular disclosure will contain, a plurality of pre-defined parameters. For example, domestic basic may contain four known parameters, including inbound sort operations, outbound sort operations, and the like, wherein each of the parameters is associated with a binary value. Continuing with the example, this may mean that a nested data structure could be used to show that for a particular date range, in Louisville, on Sunday, for the ground service group, that the domestic basic service is (or is not) operational for inbound and outbound sorting.

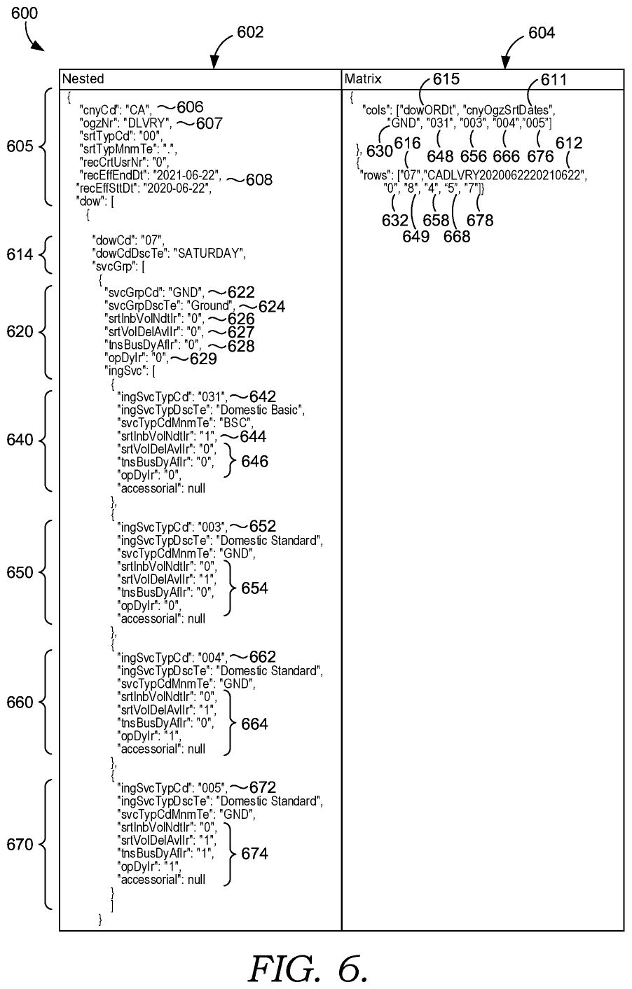

Turning now to FIG. 6, a user interface 600 illustrates the amount of coding that is required to represent operational characteristics according to the aforementioned example. Though there may be more of fewer tiers of data, the user interface 600 illustrates four tiers of data. At a first tier 610, the SLIC is identified including dates for the operational parameters that are relevant to the dataset. The first tier may be said to comprise one or more second tier data 614; in one example, the second tier may comprise the days of the week, so there may be seven second level tiers within the first level tier 605. The second tier may be said to comprise one or more third tier data 620. Continuing with the example, the third tier of data 620 illustrated in FIG. 6 is associated with a class or group of service, such as ground service. The third tier of data 620 may comprise one or more fourth tier data 640, 650, 660, 670, wherein each of the set of data at the fourth tier comprises a plurality of binary parameters.

At least one tier of data in the nested data structure will comprise a set of pre-defined parameters comprising a set of pre-defined parameters having binary values. For example, in a four-tiered dataset, only the fourth or most granular tier of data may comprise binary parameters. In other aspects, such as the aspect illustrated by user interface 600, more than one tier of data may comprise binary parameters; the third tier of data 620 and the fourth tier of data 640, 650, 660, 670 may each include one or more pre-defined parameters having binary values. The third tier of data 620 may comprise an identifier 622, a descriptor 624, a first parameter 626, a second parameter 627, a third parameter 628, and a fourth parameter 629. In the illustrated user interface 600, each of the first parameter 626, the second parameter 627, the third parameter 628, and the fourth parameter 629 are associated with “off” values, represented by a binary digit “0.” A first group of the fourth tier of data 640 may also include a set of pre-defined parameters that have binary parameters. The first group of the fourth tier of data 640 may include a first parameter 644 indicating an “on” value of “1” and each of the second, third, and fourth parameters 646 indicating an “off” value of “0.” In one aspect, where a set of pre-defined parameters includes some binary attribute-value pairs and some attribute-value pairs that are not binary, the non-binary attribute-values may be removed.

As part of the conversion from the nested data structure to the matrix data structure, the plurality of binary values associated with a set of pre-defined parameters may be represented by a single decimal value. Each subsequent binary value of each set of pre-defined parameters is concatenated to create a binary string. The binary string is then converted to a decimal number, wherein every unique number equates to a distinct binary sequence. Returning to the third tier of data 620, it may be said the first parameter 626, the second parameter 627, the third parameter 628, and the fourth parameter 629, together represent a set of four pre-defined binary parameters. When concatenating just the binary digits, a binary sequence representing said set of pre-defined binary parameters would be “0000.” Easily, when converted from binary to decimal, the string “0000” is simply “0.” In another example, the first group of the fourth tier of data 640 comprises a set of four pre-defined binary parameters, wherein the first parameter 644 is “1” and each of the second parameter, third parameter, and fourth parameter 646 is “0.” When concatenating just the binary digits, a binary sequence representing said set of pre-defined binary parameters would be “1000.” When converted from binary to decimal, the binary value “1000” becomes “8.” Thus, as part of the conversion from the nested data structure to the matrix data structure, the set of four pre-defined parameters associated with the third tier of data 620 is “0” and the set of four pre-defined parameters associate with the first group of the fourth tier of data 640 is “8.” The second group of the fourth tier 650 may have a set of pre-defined parameters 654, wherein a first, third, and fourth parameter are set to “0” and a second parameter is set to “1.” The corresponding binary sequence “0100” would be converted to the decimal value “4.” The third group of the fourth tier 660 may have a set of pre-defined parameters 664, wherein each of a first and third parameter are set to “0” and each of a second and fourth parameter is set to “1.” The corresponding concatenated binary sequence “0101” would be converted to the decimal value “5.” The fourth group of the fourth tier 670 may have a set of pre-defined parameters 674, wherein a first parameter is set to “0” and each of a second, third, and fourth parameter is set to “1.” The corresponding binary sequence “0111” would be converted to the decimal value “7.”

The nested to matrix data structure conversion is agnostic to consistency of pre-defined parameters between and within different groups of data. In the illustrated aspect, different groups of data within the same tier have the same pre-defined parameters. For example, both the set of pre-defined parameters associated with the first group of the fourth tier 640 and the second group of fourth tier 650 comprise “srtInbVolNdtIr,” “srtVolDelAvlIr,” “tnsBusDyAfIr,” “opDyIr.” It other aspects, the first group of the fourth tier 640 and the second group of the fourth tier 650 may have different pre-defined parameters. Similarly, in the illustrated aspect, the third tier of data 620 comprises the same set of pre-defined parameters as the first and second groups of the fourth tier of data 640,650, even though they are at different tiers. That is, the pre-defined parameters are the same between at least two tiers and within one of those tiers; however, because the nested to matrix conversion process is agnostic to consistency of parameters, one tier of data (e.g., the third tier of data 620) need not be the same as another tier of data (e.g., the fourth tier of data, including the first and second groups of the fourth tier data 640,650). Different groups of data, whether in the same or different tiers, may also have either the same or different numbers of pre-defined parameters (e.g., each group may have four parameters or one group may have four and another group may have six). In one hypothetical, if a first set of pre-defined parameters consisted of four binary values (e.g., “1010”) and a second set of pre-defined parameters consisted of six binary values (e.g., “100110”), the conversions would simply be “10” and “38” respectively. Regardless of what the pre-defined parameters for each tier/group of data are, a usable nested data structure will have static definitions for those pre-defined parameters. That is, if the composition and order of a set of pre-defined parameters is: 1. “srtInbVolNdtIr,” 2. “srtVolDelAvlIr,” 3. “tnsBusDyAfIr,” and 4. “opDyIr,” then the order should generally remain static.

Non-binary values corresponding to pre-defined parameters may also be in the nested data structure and can be incorporated into the matrix data structure. In the examples discussed above (e.g., the third tier of data 620, the first group of the fourth tier of data 640, etc.), pre-defined parameters consisted of attribute-value pairs having a binary value; however, non-binary attribute value pairs may also be converted into the matrix data structure. Though the greatest consolidation of data corresponds to the concatenation and conversion of a set of binary bits to a decimal number, non-binary values may be translated or converted to the matrix data structure. A non-binary numerical value may be translated from the nested data structure to the matrix data structure; for example, the second tier of data 614 may comprise attribute-values associated with a day of the week. Though the “dowCdDscTe” is “SATURDAY,” this value may be considered a display value for rendering on a user interface and may have a corresponding numeric value such as “dowCd,” which in this case is “7.” The value of “7” may simply be translated into the corresponding location in the matrix data structure as a decimal value.

Where an attribute-value pair is numeric (or numeric-based) but not in binary or decimal form, the value may be translated in any way that is deemed desirable; for example, the first level tier of data 605 may comprise a numeric date range which is not in binary or decimal form. The date range may be converted by excluding non-numeric digits and concatenating the values (e.g., a date range of 2020-06-22 to 2021-06-22 may become 2020062220200622), or it may be converted using any other desirable format. Further, where an attribute-value pair is non-numeric, the value may be converted in any way that is deemed desirable; for example, the first level tier of data 605 may comprise an attribute of “cnyCd” having a value of “CA” and an attribute of “ogzNr” having a value of “DLVRY.” The text values may be converted to hexadecimal or decimal (e.g., “CA” is translated to “6361” in hex) and stored (with or without concatenation) in the matrix data structure; in other aspects, the text values may be concatenated and stored in text format, particularly where the sequence length of the values is fixed (e.g., if “cnyCd” is fixed at a two letter length and “ogzNr” is fixed at a five letter length, then “CA” and “DLVRY” may be concatenated and translated to “CADLVRY” in the matrix data structure without any ambiguity about which text values are associated with each attribute).

The matrix data structure may generally be said to comprise an arrangement of columns and rows. Whether in text/code form, as illustrated in the user interface 600 of FIG. 6, or in a table or other spreadsheet form (e.g., CSV, .xls, and the like), each column header/label is populated with an identifier associated with one or more parameters or attributes and the corresponding row is populated with a value representing the one or more parameters or attributes. In some cases, a single column may be configured to represent a single value of an attribute-value pair; for example, the second tier of data 614 may be associated with a day of the week, so a first column header/label 615 may be “dowORDt” (representing day of the week) and the corresponding first row value 616 may be “7” (representing Saturday). In some cases, a single column may be configured to represent a plurality of values of an attribute-value pair; for example, the first level tier of data 605 may comprise a first attribute 606, a second attribute 607, and a third attribute 608, which may be combined into a single attribute-value having a second column header/label 611 (“cnyOgzSrtDates”) and the corresponding second row value 612 may be “CADLVRY2020062220210622” (representing a country code, a SLIC, and a date range for the data). Notably, even though the first column header/label 615 and the second column header/label 611 are different tiers of data in the nested data structure, they become flattened in the matrix data structure.

One or more column headers/labels may represent concatenated and converted binary data described above. For example, a third column header/label 630 may be “GND” and the corresponding third row value 632 may be “0,” translated from decimal to binary as an N-length string of 0s, representing that the third tier of data 620 comprises one or more binary attribute-value pairs, all of which are off or “0.” A fourth column header/label 648 may be “031” and the corresponding fourth row value 649 may be “8,” translated from decimal to binary as an N-length string comprising a binary string ending in “1000,” representing that the first group of the fourth tier of data 640 comprises one or more binary attribute-value pairs, all of which are off or “0” except that the first value is on or “1.” Notably, the matrix data structure may be used where the string length is known (e.g., if string length is fixed at 4, the decimal value of “8” will be converted to the first binary attribute-value pairs having a value of “1” and the second, third, and fourth binary attribute-value pairs having a value of “0;” where the string length is unknown, an N-length binary string of “1” would populate the last binary attribute-value pair with a value of “1” and populate the remaining attribute-value pairs with a “0.” Continuing, a fifth column header/label 656 may be “003” (representing an identifier 652 associated with second group of the fourth tier of data 650) and the corresponding fifth row value 658 may be “4,” translated from decimal to binary as an N-length binary string ending in “100,” representing that the second group of the fourth tier of data 650 comprises one or more pre-defined parameters 654, all of which are off or “0” except that the third to last value is on or “1.” A sixth column header/label 666 may be “004” and the corresponding sixth row value 668 may be “5,” translated from decimal to binary as an N-length binary string ending in “101,” representing that the third group of the fourth tier of data 660 comprises one or more binary attribute-value pairs, wherein the last value and the third to last value are on or “1” and all other values are off or “0.” A seventh column header/label 676 may be “005” and the corresponding seventh row value 678 may be “7,” translated from decimal to binary as an N-length binary string ending in “111,” representing that the fourth group of the fourth tier of data 670 comprises one or more binary attribute-value pairs, wherein the last three values are on or “1” and all other values are off or “0.”

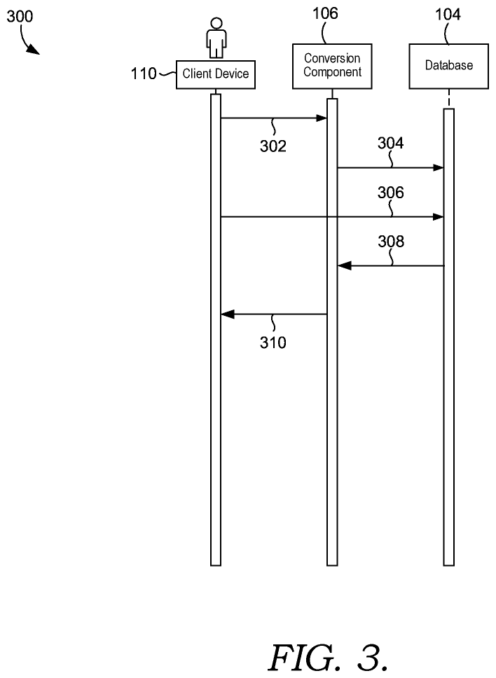

As seen side-by-side in the user interface 600, a matrix data structure 604 may be less human-perceptible or less usable by certain software than a nested data structure 602. Turning now to FIG. 3, a sequence diagram is provided for illustrating the process for converting information from a nested data structure to a matrix data structure, and back. At a first step 302, the computing device 110 of FIG. 1 communicates a first set of attribute-value information to the conversion component 106 of FIG. 1 in a nested data structure such as the nested data structure 602 of FIG. 6. The first step 302 may be initiated by the computing device 110 (e.g., if a client wishes to run a simulation on a remote device using the first set of attribute-value information) or by any other source. At a second step 304, the conversion component 106 creates a second set of attribute-value information in a matrix data structure such as the matrix data structure 604 of FIG. 6. In aspects where one or more of the nested data structure and the matrix data structure are being executed/handled within the Java Runtime Environment, a Java archive (JAR) file may be used to convert the first set of attribute-value information into the second set of attribute-value information.

Regardless of the particular form of the conversion component 106, the conversion component converts the first set of attribute-value information into the second set of attribute-value information according to any one or more of the aspects described with respect to FIG. 6. The conversion component 106 may operate at or near the client device, performing the conversion in to the matrix data structure before the second set of attribute-value information is communicated over a network (such as the network 108 of FIG. 1) to a remote location such as the storage device 104 of FIG. 1. By communicating the second set of attribute-value information (in the matrix data structure) instead of the first set of attribute-value information (in the nested data structure), real-world testing has shown a significant conservation of networking/computing resources, wherein the second set of attribute-value information is associated with a file that is merely 2.5% the size of a file associated with the first set of attribute-value information. That is, communicating the second set of attribute-value information (whether from the computing device 110 to the storage device 104, back, or from the storage device 104 to any number of other client devices that may request the data) has been shown to result in over 40 times less network resources to communicate the same attribute-value information compared to the first set of attribute-value information and similar reductions in storage requirements at the storage device 104.

At a third step 306, a client device, such as the computing device 110, communicates a request to the storage device 104 to get the second set of attribute-value information. The second set of attribute-value information is communicated at a fourth step 308 to the conversion component 106 and converted from the second set of attribute-value information into the first set of attribute-value information. At a high level, any one or more aspects described with respect to FIG. 6 that are incorporated by the conversion component 106 on the nested to matrix conversion are undone at the fourth step 308. For example, the conversion component 106 may evaluate the column headers/labels of the matrix data structure and determine that a first column header/label, such as the first column header/label 615 of FIG. 6 (“dowORDt”) is associated with a set of attribute-values corresponding to the second tier of data 614 of FIG. 6. Once the set of attribute-value is known, the corresponding row value, such as the first row value 616 of FIG. 6 may be translated, split, and/or converted into the appropriate value(s). In the case of the first column header/label 615, the conversion component 106 would know that the first row value 616 is associated with a single, translated value (“07), and populate the nested data structure with the “07.” In some aspects, the conversion component 106 may also populate data in the nested structure that is related to the converted data; for example, if an attribute-value of “dowCd”: “07” was defined as having a value of “SATURDAY,” the conversion component 106 may populate “dowCdDscTe”: with “SATURDAY.” In aspects where the number of attribute-values in a particular set of attribute-values is known, the conversion component 106 will create a binary string of the appropriate length by converting the decimal value stored in the row value of the matrix data structure and sequentially populate the attribute-value pairs. In but one example, if a set of attribute-values consists of four binary parameters, the conversion component 106 may translate a decimal value of “5” in to “0101,” and populate the first parameter attribute with a value of “0,” the second parameter attribute with a value of “1,” the third parameter attribute with a value of “0,” and the fourth parameter attribute with a value of “1.” At a fifth step 310, having converted the second set of attribute-value information to the first set of attribute-value information, the conversion component 106 communicates the first set of attribute-value information to the computing device 110.

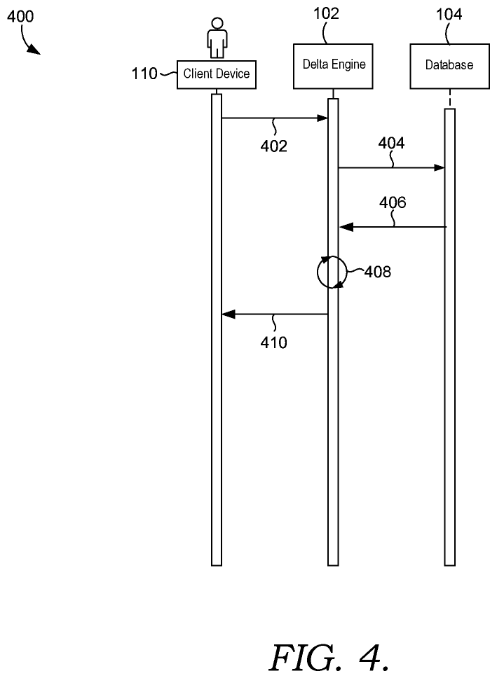

Turning now to FIG. 4, a sequence diagram is illustrated for processing changes to attribute-value information using the matrix data structure described herein. At a first step 402, a client device such the computing device 110 of FIG. 1 communicates a request to a delta engine, such as the delta engine 102 of FIG. 1, to check/obtain changes to a first version of a first set of attribute-value information being used at the computing device 110. At a second step 404, the delta engine 102, which may comprise a software stack or engine executing at or near the computing device 110, communicates a request to a database, such as the storage device 104 of FIG. 1, to obtain any changes to the first version of the first set of attribute-value information. In some aspects, the delta engine 102 may convert the first version of the first set of attribute-value information in a nested data structure into a first version of a second set of attribute-value information in a matrix data structure according to any one or more aspects described with respect to FIGS. 3 and 6; in other aspects, a conversion component may convert the first version of the first set of attribute-value information into the first version of the second set of attribute-value information according to any one or more aspects of FIG. 3 and pass the first version of the second set of attribute-value information on to the delta engine 102 (in such an aspect, the conversion component may also convert attribute-value information received from the delta engine 102 in the matrix data structure into attribute-value information in the nested data structure and pass it to the computing device 110).

In yet another aspect, the delta engine may not communicate attribute-value information at the second step 404, wherein the first version of the second set of information is stored on the storage device 104 and the second step 404 is a request to check for changes to the first version of the second set of information. At a third step 406, a response is communicated to the delta engine 102 from the storage device 104; where no changes to the first version of the second set of information are found, a confirmation message or other affirming messaging may be communicated to the delta engine 102 and passed along to the client device. Otherwise, at the third step 406, a response is communicated to the delta engine 102 with a second version of the second set of information; that is, a second version of information for the same attribute-values comprising at least one change is communicated from the storage device 104 to the delta engine 102 in the matrix data structure. At a fourth step 408, the delta engine 102 compares the first version of the second set of attribute-value information with the second version of the second set of attribute-value information. In aspects where the delta engine 102 determines that substitute data has been found, the delta engine 102 may communicate updates to the computing device 110 at a fifth step 410. In one aspect, the delta engine 102 may identify changes (e.g., substitutions, deletions, additions) between the first and second versions of the second set of attribute-value information and communicate only the changes to the computing device 110; in another aspect, the delta engine 102 may relay the entire second version of the second set of attribute-value information to the computing device 110, wherein the computing device 110 effectively replaces the first version of the first set of attribute-value information with a second version of the first set of attribute-value information.

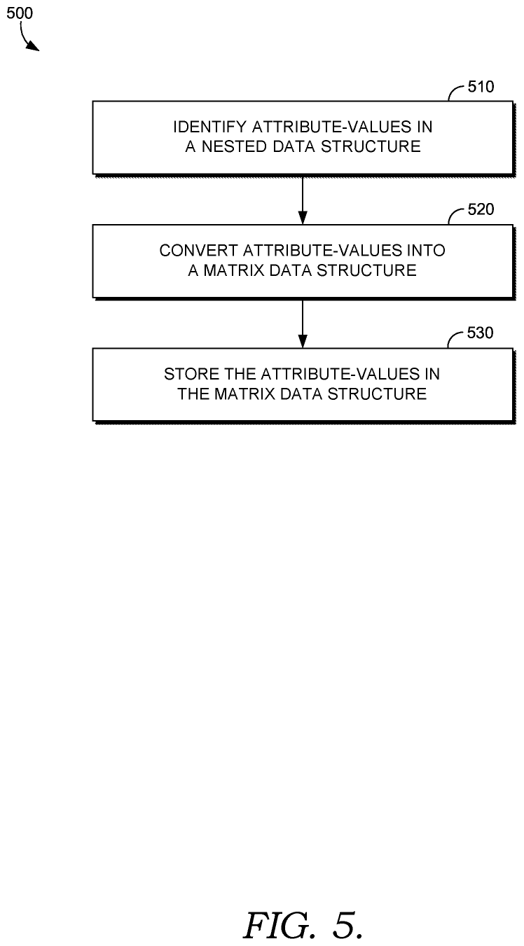

Turning now to FIG. 5, a flow diagram is illustrated for an improved method for communicating attribute-value information between networked computing components, according to the framework of the present disclosure. At a first step 510, one or more sets of attribute-values in a nested data structure are identified, wherein each set of attribute-values may comprise one or more pre-defined parameters. At a second step 520, the one or more sets of attribute-values is converted from a nested data structure to a matrix data structure according to any one or more aspects described herein with respect to FIGS. 3-4 and 6. At a third step 530, the one or more sets of attribute-values is communicated from a first computer processing component to a networked and remote computer processing or storage component in the matrix data structure, reducing the network and storage requirements otherwise required to communicate or store the one or more sets of attribute-values while in the nested data structure. In an optional fourth step, the one or more sets of attribute-values are communicated to a second networked computer processing component requesting the one or more sets of attribute-values from the networked computer storage device, in the matrix data structure, wherein the requesting computer processing component is remote from the computer storage component and different than the first computer processing component.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims. The described technology may be made without departing from the scope, it is to be understood that all matter described herein or illustrated in the accompanying drawings is to be interpreted as illustrative and not in a limiting sense.

What is claimed is:

1. An improved method for communicating attribute-value information between networked computing components, the method comprising:
identifying a set of attribute-value pairs associated with an identifier within a document, wherein the set of attribute-value pairs comprises a first attribute having a first binary value and a second attribute having a second binary value;
creating a binary sequence by concatenating the first binary value and the second binary value;
converting the binary sequence into a decimal value;
creating an entry in a matrix data structure, wherein a column value is the identifier and a row value is the decimal value; and
communicating the matrix data structure from a first networked computer processing component to a second networked computer processing component, the first networked computer processing component being remote from the second networked computer processing component.

2. The method of claim 1, further comprising identifying a second set of attribute-value pairs within the document associated with a second identifier, wherein the second set of attribute-value pairs comprises a second set attribute having a non-binary value.

3. The method of claim 2, wherein the non-binary value comprises a numeric value and the method further comprises creating a second entry in the matrix data structure, a column value of the second entry is the second identifier and a row value of the second entry is the numeric value.

4. The method of claim 2, wherein the non-binary value comprises a text value and the method further comprises creating a second entry in the matrix data structure, a column value of the second entry is the second identifier and a row value of the second entry is the text value in an alphanumeric text format.

5. The method of claim 2, wherein the non-binary value comprises a text value and the method further comprises creating a second entry in the matrix data structure, a column value of the second entry is the second identifier and a row value of the second entry is a numeric value equivalent of the text value.

6. The method of claim 2, wherein the method further comprises:
identifying a third set of attribute-value pairs within the document associated with a third identifier, wherein the third set of attribute-value pairs comprises a first text attribute and a second text attribute, the first text attribute having a first text string value and the second text attribute having a second text string value;
creating an alphanumeric sequence by concatenating the first text string value and the second text string value; and
creating a third entry in the matrix data structure, wherein a column value of the third entry is the third identifier and a row value of the third entry is the alphanumeric sequence in an alphanumeric text format.

7. The method of claim 1, wherein the method further comprises:
identifying a second set of attribute-value pairs associated with a second identifier within a document, wherein the second set of attribute-value pairs comprises the first attribute having a third binary value and the second attribute having a fourth binary value;
creating a second set binary sequence by concatenating the third binary value and the fourth binary value;
converting the second set binary sequence into a second set decimal value; and
creating a second entry in a matrix data structure, wherein a second column value is the second identifier and a second row value is the second set decimal value.

8. The method of claim 7, wherein the set of attribute-value pairs consists of the same attributes as the second set of attribute-value pairs.

9. The method of claim 7, wherein the set of attribute-value pairs comprises different attributes than the second set of attribute-value pairs.

10. The method of claim 1, wherein the method further comprises:
receiving, from the second networked computer component, a second version of the matrix data structure;
determining that the row value of the matrix data structure has been replaced by an updated row value in the second version of the matrix data structure; and
communicating an indication to the first networked computer processing component that causes a nested data structure equivalent of the second version of the matrix data structure to be displayed on a user interface of the first networked computer processing component, the nested data structure equivalent of the second version of the matrix data comprising the updated row value.

11. The method of claim 10, wherein the indication consists of the update row value and the column value.

12. A networked collaboration system comprising:
a first client device associated with a first user;
a first database; and
at least one computer processing component configured to perform operations comprising:
receiving, from the first client device, a nested data structure, the nested data structure comprising two or more tiers of data, a first tier of data comprising a first tier pre-defined parameter having a non-numeric value, and a second tier of data comprising a first group of two or more pre-defined parameters and a second group of two or more pre-defined parameters, a first parameter of the first group of two or more pre-defined parameters having a first binary value, a second parameter of the first group of two or more pre-defined parameters having a second binary value, a first parameter of the second group having a third binary value, and a second parameter of the second group having a fourth binary value;
creating a first binary sequence by concatenating the first binary value and the second binary value and creating a second binary sequence by concatenating the third binary value and the fourth binary value;
converting the first binary sequence into a first decimal value and the second binary sequence into a second decimal value;
creating a first entry in a matrix data structure comprising a first column value and a first row value, the first column value comprising a first identifier associated with the first tier pre-defined parameter and the first row value being the non-numeric value;
creating a second entry in the matrix data structure comprising a second column value and a second row value, the second column value comprising a second identifier associated with the first group of two or more pre-defined parameters and the second row value comprising the first decimal value;
creating a third entry in the matrix data structure comprising a third column value and a third row value, the third column value comprising a third identifier associated with the second group of two or more pre-defined parameters and the third row value comprising the second decimal value; and
communicating the matrix data structure from the first client device to the database.

13. The system of claim 10, further comprising a second client device, wherein the second client device is configured to receive, from the database, the matrix data structure and convert it in to the nested data structure.

14. The system of claim 13, wherein the second client device is further configured to communicate a second version of the matrix data structure to the database, the second version of the matrix data structure being different than the matrix data structure and accessible to the first client device.

15. The system of claim 10, wherein the first parameter of the first group of two or more pre-defined parameters is the same as the first parameter of the second group and the second parameter of the first group of two or more pre-defined parameters is the same as the second parameter of the second group.

16. The system of claim 10, wherein the first parameter of the first group of two or more pre-defined parameters is different than the first parameter of the second group.

17. The system of claim 10, wherein each of the nested data structure and the matrix data structure are formatted according to a javascript object notation.

18. The system of claim 16, wherein the at least one computer processing component comprises the execution of a javascript archive process.

19. A computer-readable media having machine readable instructions stored thereon, that when executed, cause one or more computer processing components to perform a method comprising:
receiving, from a database, a matrix data structure comprising a first column value associated with a first row value and a second column value associated with a second row value;
determining that the first row value is a text value;
determining that the second row value is a numeric value and that the second column value is associated with a set of pre-defined attributes having binary values;
converting the numeric value from a decimal format to a binary sequence;
splitting the binary sequence into a plurality of bits, the plurality of bits comprising a first bit and a second bit;
populating a first pre-defined attribute with the text value, a second pre-defined attribute with the first bit, and a third pre-defined attribute with the second bit to create a nested data structure; and
causing the nested data structure to be displayed on a user interface of the one or more computer processing components.

20. The computer-readable media of claim 19, wherein the determination that the second column value is associated with the set of pre-defined attributes having binary values is based on matching the second column value with a pre-defined group identifier associated with the set of pre-defined parameters.
